(19) United States
(12) Patent Application Publication
(10) Pub. No.: US 2010/0014123 A1
(43) Pub. Date: Jan. 21, 2010

(54) ONLINE HARDCOPY REVISION SERVICE

(75) Inventor: Ramesh Nagarajan, Pittsford, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/175,815

(22) Filed: Jul. 18, 2008

(51) Int. Cl. H04N 1/387; G06K 9/03

(52) U.S. Cl. 358/452; 382/311

(57) ABSTRACT

A revision control system (RCS) can maintain document revisions that contain markings. Markings are often hand written notes or drawings added to a physical document. The markings can be isolated from the original drawing and saved in the RCS as difference specifications. A physical document can be produced from a document specification. A person can add markings. A revised document specification can then be produced from the marked up version of the physical document. Finally, the revised document specification can be maintained by the RCS. As such, various document versions of the physical document, including those with hand markings, can be fetched from the RCS. A person can use the physical document to update existing revision and/or query older revisions without any manual steps.

### TECHNICAL FIELD

Embodiments are related to document scanning, document imaging, and image analysis. Embodiments are also related to revision control systems.

### BACKGROUND

A revision control system (RCS) is a system for managing documents or other data as that data is edited and revised over time. A document is stored in a RCS is under revision control, it can be retrieved, edited, and newer versions also placed under revision control. When a document is edited a new version, a revision, is created. The revision can then be stored in the RCS. Henceforth, both the document and any revisions can be retrieved and edited to create further revisions. The RCS tracks the various versions of the document. RCS systems are well known to those practiced in the art of programming wherein programming code and code histories are commonly maintained with the help of a RCS system.

There are many types of documents and revisions that can not be stored or tracked with currently available revision control systems. Systems and methods for applying revision control methodology to additional document types are needed.

### BRIEF SUMMARY

Aspects of the embodiments address limitations and flaws in the prior art by using image processing techniques or mixed raster content (MRC) technology along with revision control techniques to identify and track the differences between document versions and to thereby maintain a revision history of the document.

It is therefore an aspect of the embodiments that a document specification is an electronic representation of a physical document. For example, a pdf file is a page description language (PDL) specification that can be printed to produce an instance of the physical document.

It is another aspect of the embodiments that a revised document specification is an electronic representation of a marked up document. Marking up is the act of writing, drawing, or otherwise annotating an instance of the physical document and results in a marked up document. As such, the marked up document consists of the instance of the physical document plus the markings. The writings, drawings, or annotations comprise the markings.

It is a further aspect of the embodiments to ensure that the document specification is stored in a revision control system (RCS). As such, if the document specification is not stored in the RCS, then positive action is taken to store it in the RCS.

It is a yet further aspect of the embodiments to store the revised document specification in the RCS. The revised document specification is stored as a revision of the document specification.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention

FIG. 1 illustrates a revision control system maintaining a revision controlled document in accordance with aspects of the embodiments;

FIG. 2 illustrates scanning a physical document to obtain a revision controlled document specification in accordance with aspects of the embodiments;

FIG. 3 illustrates obtaining revised document specifications in accordance with aspects of the embodiments;

FIG. 4 illustrates an internet service maintaining revised documents for a customer in accordance with aspects of the embodiments;

FIG. 5 illustrates a high level flow diagram of maintaining a revision controlled document in accordance with aspects of the embodiments; and

FIG. 6 illustrates relationships between physical documents, document specifications, and markup in accordance with aspects of the embodiments.

### DETAILED DESCRIPTION OF THE INVENTION

The particular values and configurations discussed in these non-limiting examples can be varied and are cited merely to illustrate embodiments and are not intended to limit the scope of the invention.

A revision control system (RCS) can maintain document revisions that contain markings. Markings are often hand written notes or drawings added to a physical document. The markings can be isolated from the original drawing and saved in the RCS as difference specifications. A physical document can be produced from a document specification. A person can add markings. A revised document specification can then be produced from the marked up version of the physical document. Finally, the revised document specification can be maintained by the RCS. As such, various document versions, including those with hand markings, can be fetched from the RCS.

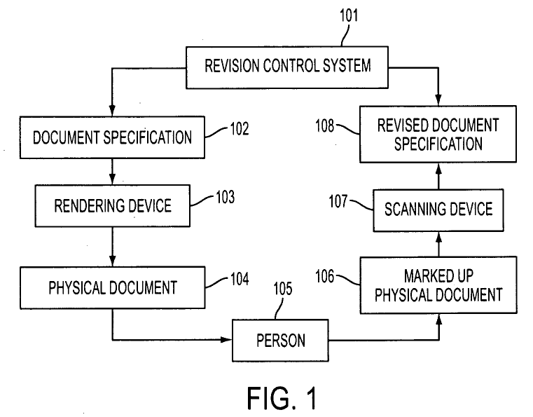

FIG. 1 illustrates a RCS 101 maintaining a revision controlled document in accordance with aspects of the embodiments. A document specification 102 can be retrieved from the RCS 101 and then submitted to a rendering device 103 to produce a physical document 104. A person 105 then adds markings to the physical document 104 to produce a marked up physical document 106. A scanner 107 can produce a revised document specification 108 from the marked up physical document 106. The revised document specification 108 can then be stored in the RCS 101 as a version of the document specification 102.

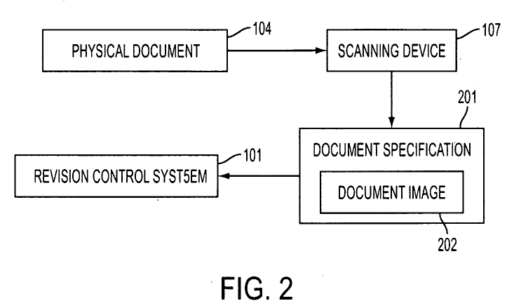

FIG. 2 illustrates a scanning device 107 scanning a physical document 104 to obtain a revision controlled document specification in accordance with aspects of the embodiments. Scanning can produce a document specification 201 that includes a document image 202 that can be simply an image of the physical document 104. The document specification 201 can then be submitted to the RCS 101 as a revision controlled document.

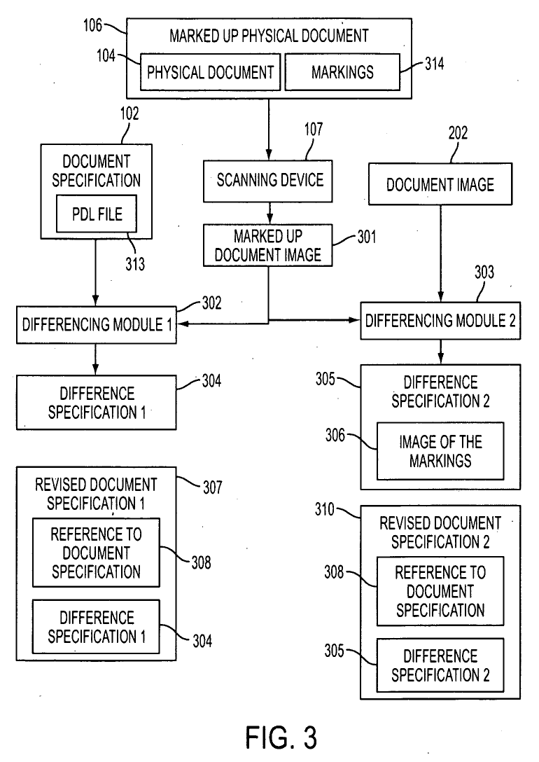

FIG. 3 illustrates obtaining revised document specifications in accordance with aspects of certain embodiments. A marked up physical document 106 is a physical document 104 with markings 314. A scanning device 107 can produce a marked up document image 301 by scanning the marked up physical document 106.

A first differencing module 302 can accept the marked up document image 301 along with the document specification 102 of the physical document 104. As illustrated, the document specification 102 contains a page description language (PDL) file. After some analysis, a first difference specification 304 is produced. A revised document specification 307 contains a reference to the document specification 308 and the difference specification 304. The reference to the document specification 308 can be used to obtain the document specification 102 from a RCS.

A second differencing module 303 can accept the marked up document image 301 and a document image 202. After some analysis, a second difference specification 305 containing an image of the markings 306 is produced. A second revised document specification 310 contains a reference to the document specification 308 and the difference specification 305.

Those skilled in the arts of image processing, mixed raster content (MRC) files, and image segmentation know of many techniques for producing difference specifications. Some of the details of these arts are taught in “Method for image segmentation to identify regions with constant foreground color” (US patent application 20050275897), “MRC image compression” (US patent application 20060056710), “Automated method for extracting highlighted regions in scanned source” (US patent application 20070253620), “Automated method and system for retrieving documents based on highlighted text from a scanned source” (US patent application 20070253643), “MRC image compression” (US patent application 20060056710), and “Compression of mixed raster content (MRC) image data” (US patent application 20050036694).

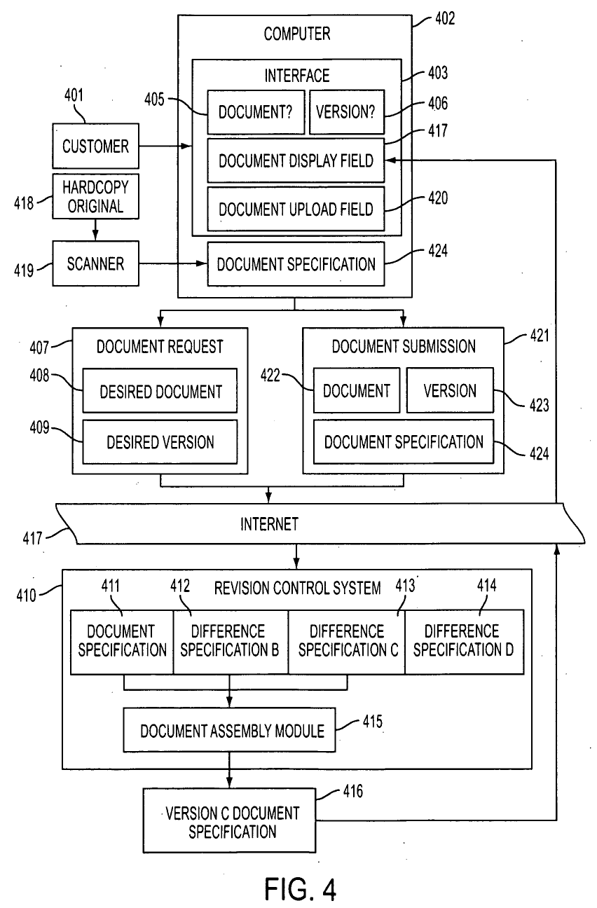

FIG. 4 illustrates an internet service maintaining revised documents for a customer 401 in accordance with aspects of certain embodiments. The customer 401 uses a computer 402 to pull up an interface 403 to the internet service. The interface has fields by which the customer 401 can select a version 406 of a document 405. The computer 402 forms a document request 407 specifying the desired version 409 of the desired document 408. The document request 407 can be sent over the internet 417 to a revision control system 410. As illustrated, the customer 401 desires version C of a document.

Version C can be produced by applying difference specification B 412 to a document specification 411 and then applying difference specification C 413 to the result. The revision control system 410 contains a document assembly module 415 that can assemble a version C document specification 416 from the specifications and the differences stored in the RCS 410.

The version C document specification 416 can then be passed through the internet 417 and back to a display field 417 where the customer 401 can view it. The customer can also print out the document to obtain a physical document.

Alternatively, the customer can use a scanner 419 to scan a hardcopy original 418 and thereby upload a document specification 424 to the computer 402 and then use a document upload field 420 in the interface 403 to form a document submission 421 specifying what version 423 of what document 422 has been uploaded. Alternatively, the system could automatically increment the revision of the document. The uploaded specification can have a document image, PDL file, MRC file, or a combination of types. The RCS can then store the submitted document as a new document or as a revision of an already stored document.

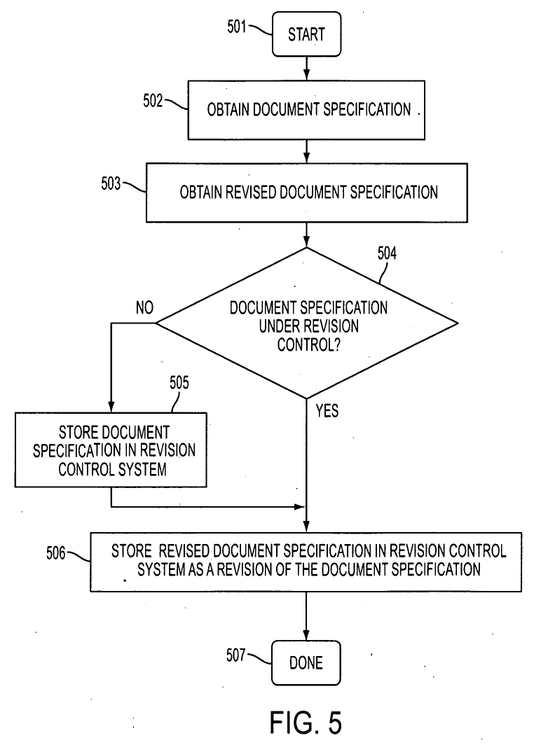

FIG. 5 illustrates a high level flow diagram of maintaining a revision controlled document in accordance with aspects of the embodiments. After the start 501 a document specification is obtained 502. A revised document specification is also obtained 503. If the document specification is not already under revision control 504 then it is stored in the revision control system 505. The revised document specification is then stored as a version of the document specification. 506 before the process is done 507.

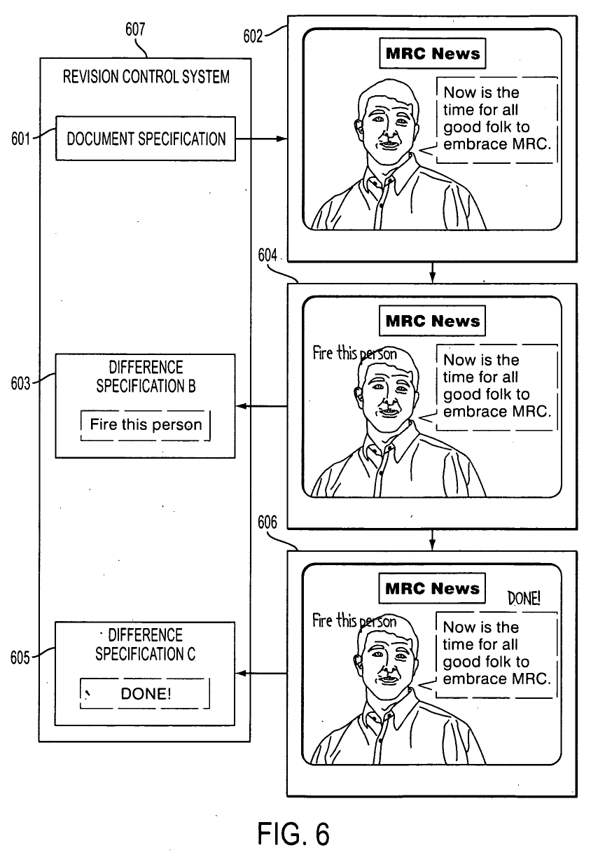

FIG. 6 illustrates relationships between physical documents, document specifications, and markings in accordance with aspects of the embodiments. A document specification 601 is obtained from a RCS 607 and used to produce a printed copy of “MRC news” 602. A first person writes, by hand, “fire this person” over a photograph of a spokesperson to thereby produce a first marked up physical document 604. Image analysis techniques separate an image of the markings to produce difference specification B 603. A second person marks “Done!” on the first marked up physical document 604 to produce a second marked up physical document 605. Image analysis techniques separate an image of the markings to produce difference specification C 605. Note that the second person could have marked up either the first marked up physical document 604 or, equivalently, a print out of version B of the original document.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
obtaining a document specification wherein the document specification is an electronic representation of a physical document;
obtaining a revised document specification wherein the revised document specification is an electronic representation of a marked up document comprising the physical document and markings on the physical document;
ensuring that the document specification is stored in a revision control system; and
storing the revised document specification in the revision control system as a revision of the document specification.

2. The method of claim 1 wherein the revised document specification comprises a reference to the document specification and a difference specification.

3. The method of claim 2 wherein the difference specification comprises an image of the markings.

4. The method of claim 1 wherein the document specification comprises a document image.

5. The method of claim 1 further comprising:
providing an interface to a customer;
accepting a hardcopy original as an input from the customer; and
accepting revision data through the interface from the customer to thereby obtain the revised document specification.

6. The method of claim 1 further comprising:
providing an interface to a customer;
accepting through the interface from the customer a document request wherein the document request specifies a desired version of a desired document; and
supplying through the interface to the customer the desired version of the desired document.

7. The method of claim 6 further comprising:
assembling the desired version of the desired document from an earlier version of the desired document and at least one difference specification comprising an image of the markings.

8. A method comprising:
obtaining a document specification wherein the document specification is an electronic representation of a physical document and wherein the document specification comprises at least one page description language file;
obtaining a revised document specification wherein the revised document specification is an electronic representation of a marked up document comprising the physical document and markings on the physical document;
ensuring that the document specification is stored in a revision control system; and
storing the revised document specification in the revision control system as a revision of the document specification.

9. The method of claim 8 wherein the document specification further comprises a difference image comprising imaged markup of a prior physical document.

10. The method of claim 8 wherein the revised document specification comprises a reference to the document specification and a difference specification.

11. The method of claim 10 wherein the difference specification comprises an image of the markings.

12. The method of claim 8 further comprising:
providing an interface to a customer; and
accepting revision data through the interface from the customer to thereby obtain the revised document specification.

13. The method of claim 8 further comprising:
providing an interface to a customer;
accepting through the interface from the customer a document request wherein the document request specifies a desired version of a desired document; and
supplying through the interface to the customer the desired version of the desired document.

14. The method of claim 13 further comprising:
assembling the desired version of the desired document from an earlier version of the desired document and at least one difference specification comprising an image of the markings.

15. A method comprising:
a step for obtaining a document specification of a physical document;
a step for obtaining a revised document specification wherein a revised document comprises the physical document and markings on the physical document;
a step for storing the revised document specification in a revision control system as a revision of the document specification.

16. The method of claim 15 wherein the revised document specification comprises a difference specification.

17. The method of claim 16 wherein the difference specification comprises an image of the markings.

18. The method of claim 15 further comprising a step for accepting revision data through an interface from a customer to thereby obtain the revised document specification.

19. The method of claim 15 further comprising
a step for accepting a document request from a customer wherein the document request specifies a desired version of a desired document; and
a step for supplying the desired version of the desired document to the customer.

20. The method of claim 19 further comprising:
a step for assembling the desired version of the desired document from an earlier version of the desired document and at least one difference specification comprising an image of the markings.
